(19) United States
(12) Patent Application Publication
(10) Pub. No.: US 2026/0064134 A1
(43) Pub. Date: Mar. 5, 2026

(54) AUTOMATIC WATERCRAFT MANEUVERING SYSTEM AND WATERCRAFT CONTROL METHOD

(71) Applicant: YAMAHA HATSUDOKI KABUSHIKI KAISHA, Iwata-shi (JP)

(72) Inventors: Hiroshi INOUE, Shizuoka (JP); Daisuke OKAMURA, Shizuoka (JP); Katsutoshi NAITO, Shizuoka (JP); Kunihiko AKAHANE, Shizuoka (JP); Hiroaki TAKASE, Shizuoka (JP); Kazumichi YOSHIDA, Shizuoka (JP); Tomohiro HIROTA, Shizuoka (JP)

(21) Appl. No.: 19/314,505

(22) Filed: Aug. 29, 2025

(30) Foreign Application Priority Data
Sep. 2, 2024 (JP) 2024-150722

(51) Int. Cl. G05D 1/85; B63B 35/00; B63B 43/18; G05D 1/221; G05D 1/622; G05D 107/00; G05D 109/30; G05D 111/10; G06V 20/56

(52) U.S. Cl. CPC G05D 1/857; B63B 35/00; B63B 43/18; G05D 1/221; G05D 1/622; G06V 20/56; B63B 2035/007; B63B 2035/008; G05D 2107/25; G05D 2109/34; G05D 2111/10

(57) ABSTRACT

An automatic watercraft maneuvering system includes a propulsion device, a steering, a position sensor, a camera, and a controller configured or programmed to execute an automatic watercraft maneuvering control to control the propulsion device and the steering in order to perform automatic watercraft maneuvering from a departure location to a destination location. The automatic watercraft maneuvering control includes a camera watercraft maneuvering control and a position sensor watercraft maneuvering control. The controller is configured or programmed to, when a failure occurs in the position sensor in a predetermined area of water in which the automatic watercraft maneuvering is executable using the camera watercraft maneuvering control, cause the watercraft to head to a predetermined target position in the predetermined area of water in which the failure occurs during the camera watercraft maneuvering control.

### CROSS REFERENCE TO RELATED APPLICATIONS

This application claims the benefit of priority to Japanese Patent Application No. 2024-150722 filed on Sep. 2, 2024. The entire contents of this application are hereby incorporated herein by reference.

### BACKGROUND OF THE INVENTION

### 1. Field of the Invention

The present invention relates to automatic watercraft maneuvering systems and watercraft control methods.

### 2. Description of the Related Art

JP 2021-91307 A discloses a watercraft maneuvering system including an automatic controller that automatically maneuvers a watercraft in an unmanned and autonomous manner. The automatic controller receives information necessary for traveling, such as a destination location, a route, and a watercraft speed, as watercraft maneuvering commands via wireless communication, and autonomously performs automatic watercraft maneuvering while detecting surrounding watercrafts and obstacles with a watercraft radar device. When an abnormal watercraft maneuvering state occurs due to hacking or malfunction of the automatic controller, an emergency command is issued from an original watercraft operator of the watercraft through wireless communication. When receiving the emergency command, the watercraft maneuvering system stops the supply of power to the automatic controller, causes the watercraft to be urgently stopped, and then performs hovering watercraft maneuvering to cause the hull to stay on the spot.

### SUMMARY OF THE INVENTION

The inventor of example embodiments of the present invention described and claimed in the present application conducted an extensive study and research regarding an automatic watercraft maneuvering system, such as the one described above, and in doing so, discovered and first recognized new unique challenges and previously unrecognized possibilities for improvements as described in greater detail below.

In JP 2021-91307 A, in an abnormal watercraft maneuvering state, the watercraft maneuvering system follows the emergency command from the original watercraft operator through wireless communication. However, depending on the situation, there is a case where appropriate watercraft maneuvering can be performed by autonomous determination by the automatic watercraft maneuvering system, and thus there is room for improvements.

Therefore, example embodiments of the present invention provide automatic watercraft maneuvering systems and watercraft control methods that each enable performing appropriate watercraft maneuvering depending on the situation.

In order to overcome the previously unrecognized and unsolved challenges described above, an example embodiment of the present invention provides an automatic watercraft maneuvering system including a propulsion device to propel a watercraft, a steering to change a course of the watercraft, a position sensor to acquire position information of the watercraft, a camera to image surroundings of the watercraft, and a controller configured or programmed to execute an automatic watercraft maneuvering control to control the propulsion device and the steering in order to perform automatic watercraft maneuvering from a departure location to a destination location. The automatic watercraft maneuvering control includes a camera watercraft maneuvering control to execute a recognition process with respect to an image acquired by the camera and control the propulsion device and the steering based on the recognition process, and a position sensor watercraft maneuvering control to control the propulsion device and the steering based on the position information acquired by the position sensor. The controller is configured or programmed to, when a failure occurs in the position sensor in a predetermined area of water in which the automatic watercraft maneuvering is executable only using the camera watercraft maneuvering control, cause the watercraft to head to a predetermined target position in the predetermined area of water in which the failure occurs during the camera watercraft maneuvering control.

According to this configuration, even when a failure occurs in the position sensor in the predetermined area of water in which the automatic watercraft maneuvering using the camera watercraft maneuvering control is executable, the automatic watercraft maneuvering with the camera watercraft maneuvering control can be continued, and the watercraft can be caused to head to the predetermined target position. Therefore, appropriate watercraft maneuvering depending on the situation can be performed based on the autonomous determination of the automatic watercraft maneuvering system.

In an example embodiment of the present invention, the predetermined target position is the departure location or the destination location.

In an example embodiment of the present invention, the controller is configured or programmed to execute the position sensor watercraft maneuvering control outside the predetermined area of water.

In an example embodiment of the present invention, the controller is configured or programmed to further execute an obstacle avoidance control to control the propulsion device and the steering such that the watercraft avoids an obstacle based on the recognition process with respect to the image acquired by the camera outside the predetermined area of water.

In an example embodiment of the present invention, the controller is configured or programmed to execute a watercraft stop control to stop the watercraft in a case where last position information acquired immediately before a failure occurs in the position sensor indicates a position outside the predetermined area of water.

Since there is a possibility that the position sensor watercraft maneuvering control cannot be appropriately performed when a failure occurs in the position sensor, it is appropriate to stop the watercraft in a case where a failure occurs in the position sensor outside the predetermined area of water. Therefore, with the above configuration, appropriate watercraft maneuvering depending on the situation can be performed based on the autonomous determination of the automatic watercraft maneuvering system.

In an example embodiment of the present invention, the automatic watercraft maneuvering system further includes an azimuth sensor to acquire azimuth information of the watercraft. The controller is configured or programmed to, when a failure occurs in the position sensor outside the predetermined area of water, execute an azimuth sensor watercraft maneuvering control to control the propulsion device and the steering such that the watercraft approaches the predetermined area of water using the azimuth information acquired by the azimuth sensor.

With this configuration, when a failure occurs in the position sensor, the watercraft can be brought close to the predetermined area of water through the azimuth sensor watercraft maneuvering control. After the watercraft enters the predetermined area of water, the controller may switch to the camera watercraft maneuvering control or perform a watercraft stop control. As described above, it is possible to perform an appropriate watercraft maneuvering depending on situations based on an autonomous determination by the automatic watercraft maneuvering system.

In an example embodiment of the present invention, the controller is configured or programmed to execute the azimuth sensor watercraft maneuvering control in a case where last position information acquired immediately before a failure occurs in the position sensor indicates a position within a predetermined distance from the predetermined area of water, and not to execute the azimuth sensor watercraft maneuvering control but to execute the watercraft stop control to stop the watercraft in a case where the last position information indicates a position outside the predetermined distance from the predetermined area of water.

With this configuration, the azimuth sensor watercraft maneuvering control or the watercraft stop control can be appropriately selected according to a distance from the predetermined area of water. As described above, it is possible to perform appropriate watercraft maneuvering depending on the situation based on an autonomous determination by the automatic watercraft maneuvering system.

In an example embodiment of the present invention, the automatic watercraft maneuvering system further includes a communication terminal to communicate with a remote watercraft maneuvering base to remotely operate the propulsion device and the steering. The controller is configured or programmed to execute a remote control to notify the remote watercraft maneuvering base of state information of the automatic watercraft maneuvering system using the communication terminal, and control the propulsion device and the steering based on a remote operation signal received from the remote watercraft maneuvering base via the communication terminal.

With this configuration, a state of the watercraft in the automatic watercraft maneuvering state can be monitored by the remote watercraft maneuvering base, and the watercraft maneuvering (remote watercraft maneuvering) using the remote control can be executed as required.

In an example embodiment of the present invention, the state information of the automatic watercraft maneuvering system includes watercraft stop control information indicating whether the controller is executing a watercraft stop control to stop the watercraft.

An example embodiment of the present invention provides a watercraft including a hull and an automatic watercraft maneuvering system on the hull. The automatic watercraft maneuvering system includes a propulsion device to propel a watercraft, a steering to change a course of the watercraft, a position sensor to acquire position information of the watercraft, a camera to image surroundings of the watercraft, and a controller configured or programmed to execute an automatic watercraft maneuvering control to control the propulsion device and the steering in order to perform automatic watercraft maneuvering from a departure location to a destination location. The automatic watercraft maneuvering control includes a camera watercraft maneuvering control to execute a recognition process with respect to an image acquired by the camera and a control of the propulsion device and the steering based on the recognition process, and a position sensor watercraft maneuvering control to control the propulsion device and the steering based on the position information acquired by the position sensor. The controller is configured or programmed to, when a failure occurs in the position sensor in a predetermined area of water in which the automatic watercraft maneuvering is executable using the camera watercraft maneuvering control, cause the watercraft to head to a predetermined target position in the predetermined area of water in which the failure occurs during the camera watercraft maneuvering control. The automatic watercraft maneuvering system may include various features as described above.

An example embodiment of the present invention provides a watercraft control method to control, with a controller, a propulsion device to propel a watercraft and a steering to change a course of the watercraft. The method includes an automatic watercraft maneuvering step to execute, with the controller, an automatic watercraft maneuvering control to control the propulsion device and the steering in order to perform automatic watercraft maneuvering from a departure location to a destination location based on an output signal of a position sensor that acquires position information of the watercraft and an output signal of a camera that images surroundings of the watercraft. The automatic watercraft maneuvering control includes a camera watercraft maneuvering control to execute a recognition process with respect to an image acquired by the camera and a control of the propulsion device and the steering based on the recognition process, and a position sensor watercraft maneuvering control to control the propulsion device and the steering based on the position information acquired by the position sensor. The watercraft control method further includes a camera watercraft maneuvering control to, when a failure occurs in the position sensor in a predetermined area of water in which the automatic watercraft maneuvering is executable using the camera watercraft maneuvering control, cause the watercraft to head to a predetermined target position in the predetermined area of water in which the failure occurs using the camera watercraft maneuvering control.

In an example embodiment of the present invention, the predetermined target position is the departure location or the destination location.

In an example embodiment of the present invention, in the automatic watercraft maneuvering control, the controller executes the position sensor watercraft maneuvering control outside the predetermined area of water.

In an example embodiment of the present invention, in the automatic watercraft maneuvering control, the controller further executes an obstacle avoidance control to control the propulsion device and the steering such that the watercraft avoids an obstacle based on the recognition process with respect to the image acquired by the camera outside the predetermined area of water.

In an example embodiment of the present invention, the method further includes a watercraft stop step to execute, with the controller, a watercraft stop control to stop the watercraft in a case where last position information acquired immediately before a failure occurs in the position sensor indicates a position outside the predetermined area of water.

In an example embodiment of the present invention, the method further includes an azimuth sensor watercraft maneuvering control to execute, with the controller, an azimuth sensor watercraft maneuvering control to control the propulsion device and the steering such that the watercraft approaches the predetermined area of water using the azimuth information acquired by the azimuth sensor when a failure occurs in the position sensor outside the predetermined area of water.

In an example embodiment of the present invention, in the method, the azimuth sensor watercraft maneuvering control is executed in a case where last position information acquired immediately before a failure occurs in the position sensor indicates a position within a predetermined distance from the predetermined area of water. The method further includes a watercraft stop control to not execute the azimuth sensor watercraft maneuvering control but to execute, with the controller, a watercraft stop control to stop the watercraft in a case where the last position information indicates a position outside the predetermined distance from the predetermined area of water.

In an example embodiment of the present invention, the controller is configured or programmed to further control a communication terminal to communicate with a remote watercraft maneuvering base to remotely operate the propulsion device and the steering. The watercraft control method further includes a remote control to execute, with the controller, a remote control to notify the remote watercraft maneuvering base of state information of the watercraft using the communication terminal, and control the propulsion device and the steering based on a remote operation signal received from the remote watercraft maneuvering base via the communication terminal.

In an example embodiment of the present invention, the state information of the watercraft includes watercraft stop control information indicating whether the controller is executing a watercraft stop control to stop the watercraft.

The controller does not need to be physically one device, and may include a plurality of physically separated devices each including a processor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram that describes an outline of a system to remotely monitor a watercraft provided with an automatic watercraft maneuvering system according to an example embodiment of the present invention.

FIG. 2 is a block diagram that describes a configuration of a watercraft by way of example.

FIG. 3 is a flowchart that describes an example of an automatic watercraft maneuvering control.

### DETAILED DESCRIPTION OF THE EXAMPLE EMBODIMENTS

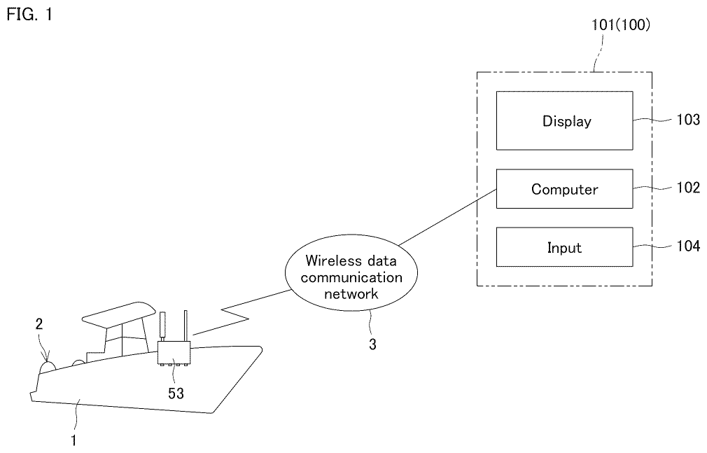

FIG. 1 is a diagram that describes an outline of a system to remotely monitor a watercraft provided with an automatic watercraft maneuvering system according to an example embodiment of the present invention.

A watercraft 1 is provided with an onboard system 2. The onboard system 2 defines an automatic watercraft maneuvering system able to autonomously maneuver the unmanned watercraft 1 from a departure location to a destination location. However, manual watercraft maneuvering by a user is performed in some cases at a departure location and/or a destination location, and manual watercraft maneuvering is performed in some cases as required even at a location other than the departure location and/or the destination location. The automatic watercraft maneuvering system is typically used in a watercraft to carry cargo such as supplies.

The onboard system 2 includes a communication terminal 53. A remote monitoring base 100 (an example of a remote watercraft maneuvering base) to monitor the watercraft 1 includes a remote monitoring system 101 (an example of a remote watercraft maneuvering system). The remote monitoring system 101 communicates with the onboard system 2 via the communication terminal 53. More specifically, the communication terminal 53 and the remote monitoring system 101 are connected to a wireless data communication network 3 such as a mobile telephone network or a satellite telephone network in a communicable manner, and are connected to each other via the wireless data communication network 3 in a communicable manner.

The communication terminal 53 transmits state information (i.e., state information of the watercraft 1) of the onboard system 2 to the remote monitoring system 101. The remote monitoring system 101 collects state information received from the communication terminal 53. The remote monitoring system 101 includes a computer 102 to process information, a display 103 to provide information to a monitoring person, and an input device 104 operated by the monitoring person. The computer 102 displays the state information received from the communication terminal 53 of the watercraft 1 on the display 103. The monitoring person ascertains the state of the watercraft 1 based on the display of the display 103. The computer 102 may display an alarm on the display 103 when a specific abnormal state occurs in the watercraft 1. In order to generate an alarm, an alarm device different from the display 103, for example, an alarm sound generating device or the like may be further provided.

The input device 104 and the display 103 of the remote monitoring system 101 define a remote watercraft maneuvering interface used to (remotely) maneuver the watercraft 1 through a remote operation. For example, when the monitoring person inputs a remote watercraft maneuvering command, the computer 102 transmits to the communication terminal 53 of the watercraft 1 a switching command to switch to a remote control mode. As a result, when the onboard system 2 switches to the remote control mode, the monitoring person can remotely maneuver the watercraft 1 by operating the remote watercraft maneuvering interface and transmitting a remote operation signal to the onboard system 2.

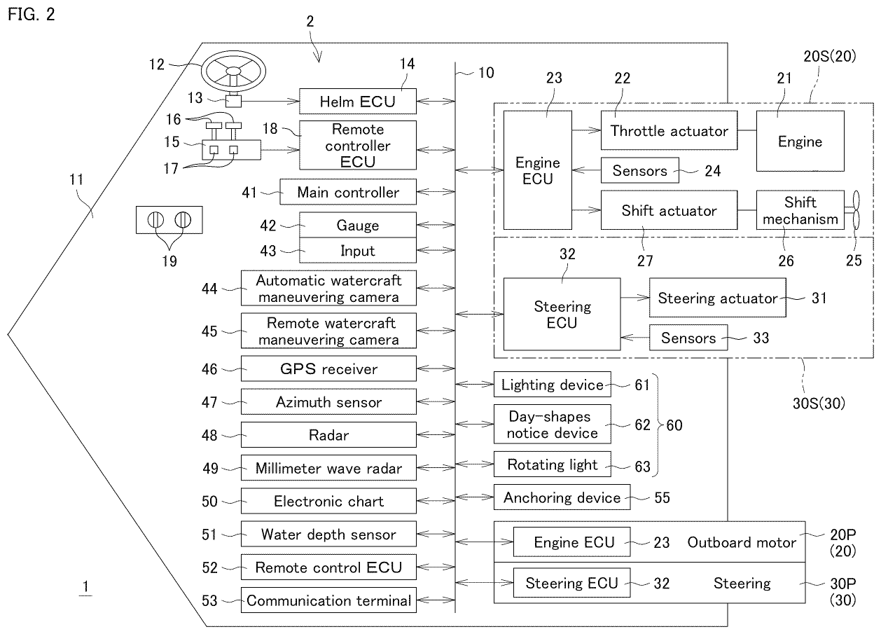

For example, an image captured by a remote watercraft maneuvering camera 45 (see FIG. 2) mounted on the watercraft 1 is transmitted from the communication terminal 53 to the remote monitoring system 101, and the image is displayed on the display 103. The monitoring person (remote watercraft operator) operates the input device 104 while viewing the image. Accordingly, the computer 102 transmits a remote operation signal to the communication terminal 53 of the watercraft 1. Remote watercraft maneuvering of the watercraft 1 is thus achieved by the onboard system 2 executing a remote control in response to the remote operation signal.

FIG. 2 is a block diagram that describes the configuration of a watercraft by way of example 1. The watercraft 1 includes a hull 11 and an onboard system 2 (automatic watercraft maneuvering system) on the hull 11. The onboard system 2 includes various devices (watercraft devices) on the hull 11. The watercraft devices include a main controller 41 to comprehensively control the devices on the watercraft 1, a propulsion device to apply a propulsive force to the hull 11, and a steering device to change the advancing direction of the hull 11. In this example embodiment, the communication terminal 53 is one of the watercraft devices. Further, in the present example embodiment, input devices (watercraft maneuvering devices) for manual watercraft maneuvering are also provided as watercraft devices. In this example, the input device includes a steering wheel 12 and a remote controller 15.

The propulsion device includes, in this example, an outboard motor 20. Specifically, one or more outboard motors 20 may be provided on the stern of the hull 11. In this example, a plurality of outboard motors 20 (more specifically, two outboard motors) are located side by side and attached to the stern. In this example, the outboard motors 20 are engine outboard motors each including an engine 21 (internal combustion engine) as a power source to drive a propeller 25. Of course, electric outboard motors each including an electric motor as a power source may be used. Specifically, the two outboard motors 20 include a port-side outboard motor 20P and a starboard-side outboard motor 20S that are attached to the stern side by side in the left-right direction.

In this example, the steering device includes steerings 30 to respectively steer the outboard motors 20 leftward and rightward. The steerings 30 are provided in one-to-one correspondence with the outboard motors 20. In this example, two steerings 30 are provided. The two steerings 30 include a port-side steering 30P and a starboard-side steering 30S, which correspond to the port-side outboard motor 20P and the starboard-side outboard motor 20S, respectively.

The steering wheel 12 is turned by a user during manual watercraft maneuvering. The operation angle of the steering wheel 12 is detected by an operation angle sensor 13, and inputted to a helm ECU (Electronic Control Unit) 14. The remote controller 15 includes acceleration levers 16 to be operated by the user to adjust the directions (forward or reverse directions) and the magnitudes of propulsive forces to be generated by the respective outboard motors 20 during manual watercraft maneuvering. The operation positions of the acceleration levers 16 are respectively detected by acceleration position sensors 17, and inputted to a remote controller ECU 18.

The outboard motors 20 each include an engine 21, a propeller 25 driven by the engine 21, a shift mechanism 26, and an engine ECU 23. The shift mechanism 26 has a plurality of shift positions, i.e., a forward shift position, a reverse shift position and a neutral shift position. With the shift position set to the forward shift position, the propeller 25 is rotated in the forward rotation direction by the driving force of the engine 21. With the shift position set to the reverse shift position, the propeller 25 is rotated in a reverse rotation direction by the driving force of the engine 21. With the shift position set to the neutral shift position, power transmission between the engine 21 and the propeller 25 is cut off. The engine ECU 23 controls the operation of a shift actuator 27 that actuates the shift mechanism 26 to control the direction of the propulsive force. Further, the engine ECU 23 controls the operation of a throttle actuator 22 that drives the throttle valve of the engine 21 to control the magnitude of the propulsive force.

The steerings 30 each include a steering actuator 31, and a steering ECU 32 to control the steering actuator 31. The steering actuator 31 generates power to pivot the corresponding outboard motor 20 leftward and rightward about its steering shaft (not shown). Thus, the direction of the propulsive force applied to the hull 11 by the outboard motor 20 is changed leftward and rightward such that the advancing direction of the watercraft 1 is changed. The steering 30 may be unitary with the corresponding outboard motor 20, or may be separate from the outboard motor 20. In FIG. 2, the steering 30 and the outboard motor 20 are configured as a unitary unit by way of example (e.g., the steering 30 is incorporated in the outboard motor 20).

The watercraft devices further include an automatic watercraft maneuvering camera 44, the remote watercraft maneuvering camera 45, a global positioning system (GPS) receiver 46, an azimuth sensor 47, a radar 48, a millimeter wave radar 49, an electronic chart 50, a water depth sensor 51, a remote control ECU 52, an anchoring device 55, a display 60, and the like. The GPS receiver 46 is an example of GNSS (Global Navigation Satellite System) positioning system, and is an example of a position sensor which detects the position of the watercraft 1.

The automatic watercraft maneuvering camera 44 includes at least one camera to image the surroundings of the watercraft 1, and is mainly used to detect an obstacle in the surroundings of the watercraft 1 during automatic watercraft maneuvering control. The remote watercraft maneuvering camera 45 includes at least one camera to image the surroundings of the watercraft 1, and is mainly used to provide an image to remotely maneuver the watercraft from the remote monitoring base 100. The azimuth sensor 47 detects an azimuth of the watercraft 1 and outputs azimuth information. The radar 48 and the millimeter wave radar 49 are used to detect an obstacle in the surroundings of the watercraft 1. The radar 48 provides obstacle information over a wide area, and the millimeter wave radar 49 is used to detect an obstacle in a short distance. The electronic chart 50 provides chart data. The remote control ECU 52 is a controller for a remote control of generating a propulsive force command and a steering command based on a command (remote operation signal) from the remote monitoring base 100. The remote control ECU 52 typically includes a processor and a memory, and is configured to provide necessary functions by the processor executing a program stored in the memory.

The anchoring device 55 includes, for example, an anchor, a rope coupled to the anchor, a reel to wind/unwind the rope, and an electric motor to drive the reel. Since the electric motor is controlled by the main controller 41, it is possible to anchor the watercraft 1 in an unmanned state and release the anchoring.

The display 60 provides visual notification, for example, to other watercrafts, of the state of the watercraft 1. The display 60 may include a lighting device 61, a day-shapes notice device 62, a rotating light 63, and the like. The lighting device 61 is mainly used for nighttime display, and the day-shapes notice device 62 is mainly used for daytime display. The rotating light 63 may be used for display in both daytime and nighttime.

The display 60 is configured to be actuated under the control of the main controller 41 to display a state (in particular, an operation state) of the watercraft 1. The display 60 is configured to be able to distinguish and display a plurality of states including a state in which the main controller 41 is executing the automatic watercraft maneuvering control and a state in which the automatic watercraft maneuvering control is not executable.

More specifically, the lighting device 61 and the day-shapes notice device 62 are configured to be able to display a watercraft stop state. The display of the watercraft stop state may be an at-anchor display. The at-anchor display using the lighting device 61 is lighting of, for example, one white all-around lamp that emits light toward the entire circumference. The at-anchor display using the day-shapes notice device 62 is a notice of, for example, one spherical day-shape (for example, a black sphere).

The lighting device 61 and the day-shapes notice device 62 are configured to be able to further display a not-under-command state. For example, when the watercraft is remotely maneuvered by the remote monitoring system 101, the not-under-command state may be displayed. The display of the not-under-command state using the lighting device 61 is lighting of two red all-around lamps located on a vertical line. The display of the not-under-command state using the day-shapes notice device 62 is two notices of spherical day-shapes (for example, black spheres) located on a vertical line.

The rotating light 63 is a light that emits light while rotating in a direction in which light is emitted toward the surroundings of the watercraft 1. The rotating light 63 may be actuated, for example, during execution of an automatic watercraft maneuvering control and/or during execution of remote watercraft maneuvering to visually notify other watercrafts of the automatic watercraft maneuvering state and/or the remote watercraft maneuvering state. For example, the automatic watercraft maneuvering state and the remote watercraft maneuvering state may be distinguished and displayed by varying a rotation speed.

A data communication network, i.e., an onboard network 10, is provided in the watercraft 1. The onboard system 2 includes the onboard network 10 and various watercraft devices connected to the onboard network 10.

The onboard network 10 is connected to the helm ECU 14, the remote controller ECU 18, the engine ECU 23, and the steering ECU 32. Therefore, the propulsive force command from the remote controller ECU 18 is transmitted to the engine ECU 23 via the onboard network 10. The propulsive force command is a command signal indicating the directions (forward or reverse directions) of the propulsive forces of the respective outboard motors 20. In the present example embodiment, the propulsive force command includes a shift command indicating a shift position of the shift mechanism 26 and an output command indicating an output (for example, a rotational speed) of the engine 21. Further, a steering command from the helm ECU 14 is transmitted to the steering ECU 32 via the onboard network 10. The steering command is a command signal corresponding to the operation direction (turning direction) and the operation angle of the steering wheel 12 and indicating the steering directions and the steering angles of the outboard motors 20.

The main controller 41 is further connected to the onboard network 10. The main controller 41 typically includes a processor and a memory, and is configured to provide necessary functions by the processor executing a program stored in the memory. The main controller 41 is programmed to execute an automatic watercraft maneuvering control. When executing the automatic watercraft maneuvering control, the main controller 41 provides a propulsive force command to the engine ECU 23 via the onboard network 10 and provides a steering command to the steering ECU 32 via the onboard network 10. Thus, the outboard motor 20 (propulsion device) and the steering 30 (steering) are controlled by the main controller 41.

The main controller 41 is also able to acquire various types of information from the remote controller ECU 18, the helm ECU 14, the engine ECU 23, and the steering ECU 32. Therefore, the main controller 41 is able to acquire, for example, the information about the steering command received by the steering ECUs 32, and information about the detection results of various sensors 33 provided on each of the steerings 30. The sensors 33 include, for example, a steering angle sensor. The steering angle sensor of the steering 30 detects the actual steering angle of the corresponding outboard motor 20. The steering angle sensor may detect the operation amount of the steering actuator 31. Further, the main controller 41 can acquire various information from the engine ECUs 23. For example, the main controller 41 is able to acquire information about the propulsive force command received by the engine ECUs 23, and information about the detection results of various sensors 24 provided on each of the outboard motors 20. The sensors 24 include, for example, a throttle opening degree sensor, an engine speed sensor, an engine temperature sensor, a coolant pressure sensor, an oil pressure sensor, a shift position sensor, a fuel pressure sensor and a residual fuel amount sensor.

The onboard network 10 is further connected to the automatic watercraft maneuvering camera 44, the remote watercraft maneuvering camera 45, the GPS receiver 46, the azimuth sensor 47, the radar 48, the millimeter wave radar 49, the electronic chart 50, the water depth sensor 51, the remote control ECU 52, the anchoring device 55, the lighting device 61, the day-shapes notice device 62, the rotating light 63, and the like. The communication terminal 53 and a gauge 42 to display various information are further connected to the onboard network 10. The communication terminal 53 may transmit information about the state of the watercraft 1 and the like, more specifically, configuration information indicating the configuration of the watercraft 1 (particularly, the onboard system 2), failure information indicating a failure occurring in the onboard system 2, the detection values of the sensors 24 and 33, and the like to the remote monitoring system 101 (see FIG. 1). Further, the communication terminal 53 transmits to the remote monitoring system 101 information about a control state by the main controller 41 as the state information of the watercraft 1. In particular, the communication terminal 53 transmits to the remote monitoring system 101 watercraft stop control information indicating whether the main controller 41 is executing the watercraft stop control. Further, the communication terminal 53 can transmit an image captured by the remote watercraft maneuvering camera 45 to the remote monitoring system 101. Further, the communication terminal 53 receives various commands from the remote monitoring system 101 and transmits the commands to the main controller 41, the remote control ECU 52, and the like via the onboard network 10.

The gauge 42 functions as a display to display, for example, the residual fuel amount, the engine speeds and the shift positions of the respective outboard motors 20, a residual battery capacity, and the like to notify the user. The gauge 42 may include an input device 43 such as input buttons and a touch panel. The input device 43 may be configured to be operated by the user to input various commands. The input device 43 may be provided separately from the gauge 42.

The steering wheel 12 and the remote controller 15 are disposed in association with a helm seat, and main switches 19 to be operated to turn on and off power supply to the respective outboard motors 20 and to start and stop the engines 21 of the respective outboard motors 20 are also provided in association with the helm seat.

The user can input a destination location by performing, for example, an operation on the input device 43. Specifically, a map read from the electronic chart 50 is displayed on the gauge 42 by performing the operation on the input device 43, and a destination location may be designated and input on the map. Of course, a destination location may be inputted by using another method such as coordinate input. The main controller 41 includes an autopilot function, acquires a current location from the GPS receiver 46, sets the acquired current location as a departure location, and calculates a route to the input destination location. The calculated route is displayed on the map in the gauge 42. The user may correct the route by operating the input device 43 as required. The main controller 41 may store the history of the routes set in the past in the memory. In this case, the user may read the history and set the route from the departure location to the destination location.

When the route is set as described above, the user operates the main switch 19 to start the engine 21 of the outboard motor 20, and inputs an automatic watercraft maneuvering start command from the input device 43 and disembarks. Thus, the watercraft 1 enters an unmanned state. Upon receiving the automatic watercraft maneuvering start command, the main controller 41 starts the automatic watercraft maneuvering control after the waiting time required for the user to disembark. The automatic watercraft maneuvering control controls the outboard motor 20 (propulsion device) and the steering 30 (steering) in order to perform automatic watercraft maneuvering from the departure location to the destination location.

The main controller 41 issues a propulsive force command and a steering command such that the current position detected by the GPS receiver 46 moves to the destination location along the set route while avoiding obstacles based on outputs from the automatic watercraft maneuvering camera 44, the radar 48, the millimeter wave radar 49, and the like. The propulsive force command is provided to the engine ECU 23, and the steering command is provided to the steering ECU 32. The engine ECU 23 controls the shift actuator 27 and the throttle actuator 22 according to the propulsive force command. The steering ECU 32 controls the steering actuator 31 according to the steering command. Thus, a propulsive force having a magnitude and a direction corresponding to the propulsive force command and the steering command acts on the hull 11.

Upon arrival at the destination location, a user waiting at the destination location gets on the watercraft 1 by performing a predetermined mooring work, and operates the input device 43 to input an automatic watercraft maneuvering control end command. Thus, the main controller 41 ends the automatic watercraft maneuvering control. The user may move the watercraft 1 by manual watercraft maneuvering as required, or may stop the engine 21 by operating the main switch 19.

There may be a case where the watercraft 1 is forced to stay on water away from both the destination location and the departure location. For example, in a case where there is a possibility that the obstacle detection becomes unreliable due to a defect of the automatic watercraft maneuvering camera 44, it is preferable to interrupt or stop the automatic watercraft maneuvering control. In such a case, watercraft maneuvering based on remote operation from the remote monitoring system 101 (remote watercraft maneuvering) is performed in some cases.

The remote watercraft maneuvering may be started by a remote watercraft maneuvering start command from the remote monitoring system 101. In the remote monitoring system 101, when the monitoring person performs a predetermined input operation, a remote watercraft maneuvering start command is transmitted to the communication terminal 53 of the watercraft. The communication terminal 53 that has received the remote watercraft maneuvering start command provides the remote watercraft maneuvering start command to the main controller 41 and the remote control ECU 52. Thus, the main controller 41 stops the automatic watercraft maneuvering control and enters the remote control mode, and the remote control ECU 52 starts the control (remote control) for the watercraft maneuvering using the remote operation. In the remote control mode, the main controller 41 transmits an image captured by the remote watercraft maneuvering camera 45 to the remote monitoring system 101 via the communication terminal 53.

In the remote monitoring system 101, the monitoring person (remote operator) performs an input operation for remote watercraft maneuvering while displaying the image received via the communication terminal 53 on the display 103, and causes the computer 102 to issue a remote operation signal. This remote operation signal is transmitted to the communication terminal 53 and provided from the communication terminal 53 to the remote control ECU 52. The remote controller ECU 52 converts a remote operation signal received via the communication terminal 53 into a propulsive force command and a steering command in a format compatible with the onboard system 2. Then, the remote control ECU 52 provides a propulsive force command to the engine ECU 23 and provides a steering command to the steering ECU 32. The engine ECU 23 controls the shift actuator 27 and the throttle actuator 22 according to the propulsive force command. The steering ECU 32 controls the steering actuator 31 according to the steering command. Thus, a propulsive force having a magnitude and a direction corresponding to the remote operation signal acts on the hull 11.

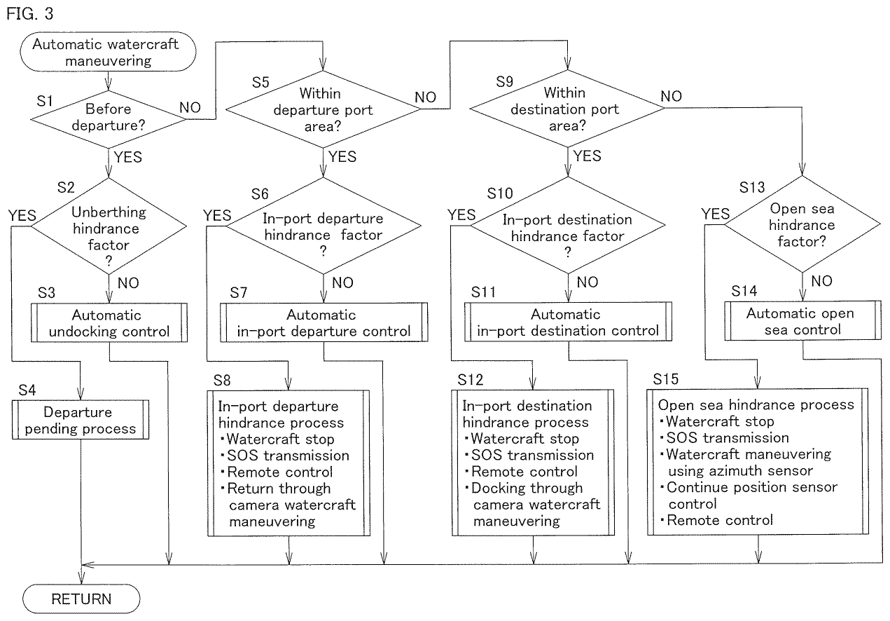

FIG. 3 is a flowchart that describes an example of an automatic watercraft maneuvering control performed by the main controller 41.

In the present example embodiment, the automatic watercraft maneuvering control (automatic watercraft maneuvering step) includes a camera watercraft maneuvering control to execute a recognition process with respect to an image acquired by the automatic watercraft maneuvering camera 44, and control a propulsion device (in the present example embodiment, the outboard motor 20; the same applies hereinafter) and a steering (in the present example embodiment, the steering 30; the same applies hereinafter) based on a result of the recognition process. Further, the automatic watercraft maneuvering control of the present example embodiment includes a position sensor watercraft maneuvering control to control the propulsion device and the steering based on position information acquired by the GPS receiver 46, which is an example of a position sensor.

In the present example embodiment, a mode of the automatic watercraft maneuvering control differs depending on the area of water in which the watercraft 1 is located, or the handling of the watercraft 1 when a hindrance to the automatic watercraft maneuvering control occurs. In the present example embodiment, the classification of the area of water from the viewpoint of the automatic watercraft maneuvering control includes a departure port area of water which is an area of water in the vicinity of a port (departure port) of a departure location, a destination port area of water which is an area of water in the vicinity of a port (destination port (arrival port)) of a destination location (arrival place), and an out-of-port area of water which is an area of water through which the watercraft 1 passes between the departure port area of water and the destination port area of water. The departure port area of water is typically within the port or harbor of departure port and may include areas of water in the vicinity thereof. The destination port area of water is typically within the port or harbor of the destination port and may include areas of water in the vicinity thereof. The out-of-port area of water is typically open sea area of water outside ports and harbors.

The departure port area of water and the destination port area of water are predetermined areas of water in which automatic watercraft maneuvering can be performed by the camera watercraft maneuvering control regardless of the position sensor watercraft maneuvering control. For each port registered in the electronic chart 50, such a predetermined area of water is determined in advance, and data is registered in the electronic chart 50. Therefore, the predetermined area of water registered for the port of the departure location is the departure port area of water, and the predetermined area of water registered for the port of the destination location is the destination port area of water. When there are one or more ports (intermediate ports) of intermediate points between the departure port and the destination port on the route, the intermediate point may be regarded as a destination location (intermediate destination location) until arrival at the intermediate point, and when leaving the intermediate point, the intermediate point may be regarded as a departure location.

An area of water outside the predetermined area of water registered for each port is an out-of-port area of water. In the automatic watercraft maneuvering control in the out-of-port area of water, the position sensor watercraft maneuvering control is mainly used, and the camera watercraft maneuvering control is supplementarily used to avoid obstacles. That is, the obstacle avoidance control to control the propulsion device and the steering to avoid an obstacle based on the recognition process with respect to the image acquired by the automatic watercraft maneuvering camera 44 is performed.

The automatic watercraft maneuvering control preferably includes an automatic undocking control to undock the watercraft from a pier of the departure location at the time of departure. Further, the automatic watercraft maneuvering control preferably includes an automatic docking control to dock the watercraft at a pier of the destination location at the time of arrival. Typically, the automatic watercraft maneuvering control preferably includes an automatic undocking control, an automatic in-port departure control, an automatic open sea control, an automatic in-port destination control, and an automatic docking control. The automatic in-port departure control is an automatic watercraft maneuvering control in a departure port area of water. The automatic open sea control is an automatic watercraft maneuvering control in an out-of-port area of water. The automatic in-port destination control is an automatic watercraft maneuvering control in a destination port area of water.

As described above, the user inputs the destination location and sets the route by using the input device 43 or the like, and inputs the automatic watercraft maneuvering start command and disembarks. Then, the main controller 41 specifies a departure port area of water by using the current location detected by the GPS receiver 46 and the electronic chart 50. Further, the main controller 41 specifies a destination port area of water by using the inputted destination location and the electronic chart 50. The main controller 41 then sets an area of water including the route between the departure port area of water and the destination port area of water as an out-of-port area of water.

Prior to unberthing (departure), the main controller 41 determines whether or not the automatic undocking control can be started, i.e., whether or not unberthing can be performed. That is, the main controller 41 determines whether the watercraft is before departure (step S1), and, when the watercraft is before departure, determines whether or not there is an unberthing hindrance factor (step S2). When it is determined that there is no unberthing hindrance factor (step S2: NO), the automatic undocking control (step S3) is started. The automatic undocking control automatically undocks the watercraft 1 from the pier to unberth the watercraft 1 using the camera watercraft maneuvering control of performing image recognition with respect to an image (video) of the surroundings of the watercraft captured by the automatic watercraft maneuvering camera 44 and issuing a propulsive force command and a steering command while automatically analyzing the recognition results.

When it is determined that there is an unberthing hindrance factor that hinders the automatic undocking control (step S2: YES), the automatic undocking control is not performed, i.e., the watercraft 1 is not unberthed, and a departure pending process (step S4) is executed. The departure pending process may include a hindrance factor display process to display the unberthing hindrance factor on the gauge 42. Further, the departure pending process may include an alarm process to generate an alarm indicating that an unberthing hindrance factor has occurred. The alarm process may be an alarm sound generation process, a notification process to the remote monitoring system 101 via the communication terminal 53, a notification process from the communication terminal 53 to a mobile terminal (for example, a smartphone held by a person in charge at the departure port) registered in advance, or the like.

For example, unberthing hindrance factors may include hindrance factors related to the automatic watercraft maneuvering camera 44, the remote watercraft maneuvering camera 45, the remote control ECU 52, the communication terminal 53, the GPS receiver 46, the radar 48, the millimeter wave radar 49, the electronic chart 50, the propulsion device (outboard motor 20), the steering (steering 30), and the like, and may further include other hindrance factors.

The unberthing hindrance factors related to the automatic watercraft maneuvering camera 44 may include, for example, a complete failure, water droplet adhesion, backlight, wave reflection, attachment position deviation, and the like. The “complete failure” includes a state in which an output image of the automatic watercraft maneuvering camera 44 cannot be acquired. The “water droplet adhesion” includes a state in which a water droplet appears in an output image of the automatic watercraft maneuvering camera 44. The “backlight” includes a state in which an output image of the automatic watercraft maneuvering camera 44 is collapsed due to the backlight. The “wave reflection” includes a state in which strong reflected light from the water surface appears in an output image of the automatic watercraft maneuvering camera 44 and thus image collapse occurs. The “attachment position deviation” includes a state in which a relative position between the imaging area of the automatic watercraft maneuvering camera 44 and the hull 11 deviates from a predetermined position. When these hindrance factors are reported and an unberthing pending state occurs, the unberthing, i.e., the automatic undocking control, can be started in some cases as a result of a person in charge at the departure port has taken necessary measures to eliminate the hindrance factors. For example, when the backlight or the wave reflection is a hindrance factor, the hindrance factor can be eliminated by the person in charge at the departure port changing the orientation of the watercraft 1 by manual watercraft maneuvering. The water droplet adhesion can be eliminated in some cases by actuating a water droplet removal device such as a wiper or an air blowing device. Therefore, when the water droplet adhesion is detected, the main controller 41 may actuate the water droplet removal device, and when the water droplet adhesion cannot be eliminated despite the actuation of the water droplet removal device, the main controller 41 may detect the water droplet adhesion as the unberthing hindrance factor.

Unberthing hindrance factors related to the remote watercraft maneuvering camera 45 may include, for example, a complete failure, water droplet adhesion, backlight, wave reflection, attachment position deviation, and the like, which are similar to the hindrance factors related to the automatic watercraft maneuvering camera 44. When there is a hindrance factor related to the remote watercraft maneuvering camera 45, it is preferable not to unberth because the automatic watercraft maneuvering cannot be switched to the remote watercraft maneuvering. Handling of the hindrance factor may be similar to the case of the automatic watercraft maneuvering camera 44. Further, the same applies to the water droplet adhesion. When the water droplet adhesion is detected, the main controller 41 may actuate the water droplet removal device, and when the water droplet adhesion cannot be eliminated despite the actuation of the water droplet removal device, the main controller 41 may detect the water droplet adhesion as the unberthing hindrance factor.

An unberthing hindrance factor related to the remote control ECU 52 may be a complete failure. For example, when the main controller 41 cannot establish communication with the remote control ECU 52, or when the remote control ECU 52 is sending an error code indicating a device abnormality, it may be determined that the remote control ECU 52 has failed. When there is a hindrance factor related to the remote control ECU 52, it is preferable not to unberth because the automatic watercraft maneuvering cannot be switched to the remote watercraft maneuvering.

Unberthing hindrance factors related to the communication terminal 53 may include, for example, a complete failure, out of communication range, and the like. The “complete failure” may be a state in which the main controller 41 cannot communicate with the communication terminal 53 or a state in which the communication terminal 53 is transmitting an error code indicating a device abnormality. The “out of communication range” may be a state in which the communication terminal 53 cannot establish communication with the remote monitoring system 101, and a state in which communication terminal 53 is sending an error code indicating an out of communication range. When communication with the remote monitoring system 101 cannot be established, it is preferable not to unberth because the state of the watercraft 1 in the automatic watercraft maneuvering state cannot be monitored and he automatic watercraft maneuvering cannot be switched to the remote watercraft maneuvering.

Unberthing hindrance factors related to the GPS receiver 46 may include, for example, a complete failure, a large error, an instantaneous interruption, a satellite loss, or the like. The “complete failure” includes a state in which the main controller 41 cannot acquire the occurrence data of the GPS receiver 46. The “large error” includes a state in which, in a case where the GPS receiver 46 provides error data together with positional data and the like, the error data exceeds a predetermined threshold value. The “instantaneous interruption” includes a state in which radio waves from a satellite are not temporarily received by a structure such as a bridge. The “satellite loss” includes a state in which radio waves from a necessary number of positioning satellites are not received. When these hindrance factors are reported and an unberthing pending state occurs, the unberthing, i.e., the automatic undocking control can be started in some cases as a result of a person in charge at the departure port has taken necessary measures to eliminate the hindrance factors. For example, the “large error,” the “instantaneous interruption,” and the “satellite loss” may be eliminated in some cases by waiting for a while or changing the position of the watercraft 1 by manual watercraft maneuvering.

The unberthing hindrance factors related to the radar 48 and the millimeter wave radar 49 may include, for example, a complete failure, attachment position deviation, and the like. When the main controller 41 cannot communication with the radar 48 and the millimeter wave radar 49, it may be determined that the radar 48 and the millimeter wave radar 49 are in a “complete failure” state. Further, when the radar 48 and the millimeter wave radar 49 do not appropriately detect a known obstacle (land, a building, or the like) around the current location (for example, when the obstacle is not consistent with the electronic chart data), the main controller 41 may determine that “attachment position deviation” occurs in the radar 48 and the millimeter wave radar 49. The person in charge at the departure port can eliminate the hindrance factor in some cases by checking the attachment states of the radar 48 and the millimeter wave radar 49 and correcting the attachment positions as required.

Unberthing hindrance factors related to the electronic chart 50 may include a detected topography mismatch. The “detected topography mismatch” includes a case where a difference between a water depth detected by the water depth sensor 51 and a water depth indicated by the electronic chart 50 is larger than a threshold. The cause of this hindrance factor is often that the position of the watercraft 1 is not suitable for unberthing, rather than the failure of the electronic chart 50. There is a possibility that the hindrance factor can be eliminated by moving the watercraft 1 to a position suitable for undocking according to manual watercraft maneuvering by the person in charge at the departure port.

Unberthing hindrance factors related to the propulsion device may include, for example, a hindrance factor related to the shift mechanism 26, and are specifically a failure of the shift actuator 27, sticking of the shift mechanism 26, disconnection of the shift position sensor, and the like. The failure of the shift actuator 27 includes a state in which the shift actuator 27 cannot be actuated, and includes a case where there is an abnormality in the shift actuator 27 and a case where the power supply line of the shift actuator 27 is disconnected. The sticking of the shift mechanism 26 includes a failure in which the shift position cannot be changed. The disconnection of the shift position sensor includes a failure in which the output of the shift position sensor cannot be acquired and the shift position cannot be detected. Typically, these failures are detected by the engine ECU 23 and reported to the main controller 41, and repair is required for unberthing. Unberthing hindrance factors related to the propulsion device include, for example, a hindrance factor related to the throttle, and are specifically a failure of the throttle actuator 22, sticking of the throttle valve, disconnection of the throttle opening degree sensor, and the like. The failure of the throttle actuator 22 includes a state in which the throttle actuator 22 cannot be actuated, and includes a case where there is an abnormality in the throttle actuator 22 and a case where the power supply line of the throttle actuator 22 is disconnected. The sticking of the throttle valve includes a case where the opening degree of the throttle valve cannot be changed or there is a large delay in changing the opening degree. The disconnection of the throttle opening degree sensor is a state in which the output of the throttle opening degree sensor cannot be outputted and the throttle valve opening degree cannot be detected. Typically, these failures are detected by the engine ECU 23 and reported to the main controller 41, and repair is required for unberthing.

Unberthing hindrance factors related to the steering may include a failure of the steering actuator 31, sticking of the steering mechanism, disconnection of the steering angle sensor, and the like. The failure of the steering actuator 31 includes a state in which the steering actuator 31 cannot be actuated, and includes a case where there is an abnormality in the steering actuator 31 and a case where the power supply line of the steering actuator 31 is disconnected. The sticking of the steering mechanism includes a failure in which a steering angle cannot be changed. The disconnection of the steering angle sensor includes a failure in which the output of the steering angle sensor cannot be acquired and the steering angle cannot be detected. Typically, these failures are detected by the steering ECU 32 and reported to the main controller 41, and repair is required for unberthing.

Other examples of unberthing hindrance factors may include a case where the shape of the pier is complicated and is not suitable for the automatic undocking control, a case where there are many traffic of other watercrafts and is not suitable for the automatic undocking control, a case where the engine 21 is not in an operation state, and a case where a residual fuel amount is less than a threshold. In these cases, the person in charge at the departure port can eliminate the hindrance factors by taking necessary measures.

After starting the automatic undocking control and departing (undocking) (step S1: NO), the main controller 41 determines whether the current position of the watercraft 1 is within the departure port area of water (step S5). Specifically, the main controller 41 acquires position data detected by the GPS receiver 46, and determines whether the current position indicated by the position data is within the departure port area of water. When the current position is within the departure port area of water (step S5: YES), the main controller 41 determines whether or not to execute (start or continue) the automatic in-port departure control.

Whether or not to execute the automatic in-port departure control is determined by the presence or absence of a hindrance factor (in-port departure hindrance factor) that hinders the automatic in-port departure control (step S6). When it is determined that there is no in-port departure hindrance factor and execution (start or continuation) of the automatic in-port departure control is possible (step S6: NO), the automatic in-port departure control is executed (step S7). The automatic in-port departure control includes, for example, a control of causing the watercraft 1 to automatically travel along a planned route using the camera watercraft maneuvering control of image recognition with respect to an image (video) of the surroundings of the watercraft captured by the automatic watercraft maneuvering camera 44 and automatically analyzing the recognition results. When it is determined that there is an in-port departure hindrance factor (step S6: YES) and the automatic in-port departure control is not executable, the main controller 41 executes an in-port departure hindrance process (step S8).

The in-port departure hindrance process may include an alarm process to generate an alarm indicating that a hindrance factor (in-port departure hindrance factor) from which it is determined that the automatic in-port departure control is not executable (started or continued) has occurred. The alarm process may be an alarm sound generation process, a notification process to the remote monitoring system 101 via the communication terminal 53, a notification process from the communication terminal 53 to a mobile terminal (for example, a smartphone held by a person in charge at the departure port) registered in advance, or the like.

The in-port departure hindrance process may include an automatic watercraft stop control. The automatic watercraft stop control stops the watercraft 1 to keep the watercraft 1 at the position. Specifically, the automatic watercraft stop control may include an at-anchor control of actuating the anchoring device 55 to anchor and berth the watercraft. Further, the automatic watercraft stop control may include a fixed point holding control of holding the current position of the watercraft 1 by controlling the propulsion device and the steering where possible. Further, the in-port departure hindrance process may include, depending on a specific hindrance factor, a camera watercraft maneuvering return process to return to the departure location (an example of a predetermined target position) using the camera watercraft maneuvering control.

For example, the in-port departure hindrance factor includes hindrance factors related to the automatic watercraft maneuvering camera 44, the remote watercraft maneuvering camera 45, the remote control ECU 52, the communication terminal 53, the GPS receiver 46, the radar 48, the millimeter wave radar 49, the electronic chart 50, the propulsion device (outboard motor 20), the steering (steering 30), and the like, and may further include other hindrance factors.

The in-port departure hindrance factor related to the automatic watercraft maneuvering camera 44 may be similar to the case of the unberthing hindrance factor. When a hindrance factor related to the automatic watercraft maneuvering camera 44 occurs, the main controller 41 executes the watercraft stop control as the in-port departure hindrance process. In this case, where possible, it is possible to take necessary measures by switching to remote watercraft maneuvering from the remote monitoring system 101 (remote control step). When complete failure is a hindrance factor, the in-port departure hindrance process preferably includes an SOS transmission process. When the backlight is a hindrance factor, the hindrance factor may be eliminated in some cases by changing the orientation of the watercraft 1 through remote watercraft maneuvering. In a case where the hindrance factor related to the automatic watercraft maneuvering camera 44 cannot be eliminated, the watercraft 1 is preferably returned to the departure location through remote watercraft maneuvering as much as possible.

An in-port departure hindrance factor related to the remote watercraft maneuvering camera 45 may be similar to the case of the unberthing hindrance factor. When a hindrance factor related to the remote watercraft maneuvering camera 45 occurs, the main controller 41 executes the watercraft stop control. In this case, where possible, it is possible to take necessary measures by switching to remote watercraft maneuvering from the remote monitoring system 101 (remote control step). When complete failure is a hindrance factor, the in-port departure hindrance process preferably includes an SOS transmission process. For example, when the backlight is a hindrance factor, the hindrance factor may be eliminated in some cases by changing the orientation of the watercraft 1 through remote watercraft maneuvering. In a case where the hindrance factor cannot be eliminated, the watercraft 1 is preferably returned to the departure location through remote watercraft maneuvering as much as possible. Further, even in a case where there is a hindrance factor in the remote watercraft maneuvering camera 45, the camera watercraft maneuvering control can be performed. Therefore, the in-port departure hindrance process when there is an in-port departure hindrance factor related to the remote watercraft maneuvering camera 45 preferably includes the camera watercraft maneuvering return process to return to the departure location using the camera watercraft maneuvering control (camera watercraft maneuvering step).

An in-port departure hindrance factor related to the remote control ECU 52 and an in-port departure hindrance factor related to the communication terminal 53 are similar to the case of the unberthing hindrance factor. The in-port departure hindrance process when there is an in-port departure hindrance factor related to the remote control ECU 52 or an in-port departure hindrance factor related to the communication terminal 53 preferably includes the camera watercraft maneuvering return process to return to the departure location through camera watercraft maneuvering control.

An in-port departure hindrance factor related to the GPS receiver 46 may be similar to the case of the unberthing hindrance factor. The in-port departure hindrance process in a case where the “complete failure” of the GPS receiver 46 is detected preferably includes the watercraft stop control. Thereafter, where possible, it is preferable to switch to remote watercraft maneuvering using the remote monitoring system 101 to return the watercraft 1 to the departure location (remote control step). The in-port departure hindrance process in the case of “large error” preferably includes the watercraft stop control. In this case, it is preferable to wait until the error recovers to a state of being equal to or less than a threshold. Since the “instantaneous interruption” occurs in a case of passing under a bridge or the like, for example, with reference to the electronic chart 50, in a case where it is usual that the instantaneous interruptions occur, it may be determined that the instantaneous interruption is not an in-port departure hindrance factor. With respect to unexpected instantaneous interruptions, for example, in a case where the instantaneous interruption occurs a predetermined number of times or more within a predetermined time, it is determined as the occurrence of a hindrance factor and the watercraft stop control may be performed as the in-port departure hindrance process. Thereafter, where possible, it is preferable to switch to remote watercraft maneuvering to return the watercraft 1 to the departure location. In the case of the “satellite loss,” the in-port departure hindrance process preferably includes the watercraft stop control, similarly to the case of the “large error.” In this case, it is preferable to wait until radio waves of the necessary number of satellites are again acquired and the error recovers to a state of being equal to or less than the threshold. When a long time elapses without recovery, it is preferable to switch to remote watercraft maneuvering to return the watercraft 1 to the departure location.

Since the automatic watercraft maneuvering in the departure port area of water is performed by the camera watercraft maneuvering control, it is not necessary to use the position data detected by the GPS receiver 46. Therefore, the in-port departure hindrance process for a hindrance factor related to the GPS receiver 46 may be a camera watercraft maneuvering return process to cause the watercraft to dock at the pier of the departure location through automatic watercraft maneuvering using the camera watercraft maneuvering control.

In-port departure hindrance factors related to the radar 48, the millimeter wave radar 49, and the electronic chart 50 are similar to the case of the unberthing hindrance factor. The in-port departure hindrance process when there is a hindrance factor related to the radar 48, the millimeter wave radar 49, or the electronic chart 50 preferably includes a camera watercraft maneuvering return process to return to the departure location through camera watercraft maneuvering control.

As in the case of the unberthing hindrance factor, in-port departure hindrance factors related to the propulsion device include a hindrance factor related to the shift mechanism 26 and a hindrance factor related to the throttle. Further, a hindrance factor related to the steering is also similar to the case of the unberthing hindrance factor. The in-port departure hindrance process in a case where a hindrance factor related to the propulsion device or the steering occurs preferably includes the watercraft stop control. Further, the in-port departure hindrance process in this case preferably includes the SOS transmission process. In a case where a hindrance factor has occurred in the propulsion device or the steering, it is generally difficult to perform remote watercraft maneuvering.

Other examples of the in-port departure hindrance factor include collision with an obstacle such as an embankment or another watercraft, and traveling in shallow water. These can be detected by providing an appropriate sensor and may be recognized by the main controller 41. When these hindrance factors occur, the main controller 41 preferably performs the watercraft stop control and the SOS transmission process as the in-port departure hindrance process. Further, the main controller 41 may, in some cases, stop the camera watercraft maneuvering control based on the image acquired by the automatic watercraft maneuvering camera 44. Specifically, there are a case where a bank gap cannot be recognized from the image acquired by the automatic watercraft maneuvering camera 44, a case where the route cannot be restored to the planned route due to the influence of a strong water flow or the like, and a case where the recognition process with respect to the image of the automatic watercraft maneuvering camera 44 becomes poor due to lack of brightness. When these hindrance factors occur, the main controller 41 preferably performs the watercraft stop control as the in-port departure hindrance process. Then, as much as possible, it is preferable to switch to the remote watercraft maneuvering from the remote monitoring system 101 and try to return to the route toward the destination location (remote control step).

When the watercraft leaves the departure port area of water through automatic watercraft maneuvering using the automatic in-port departure control (step S5: NO and step S9: NO), the watercraft enters an out-of-port area of water (open sea area of water) between the departure port area of water and the destination port area of water. As a result, the main controller 41 determines whether or not to execute (start or continue) the automatic open sea control. Specifically, it is determined whether or not there is a hindrance factor (open sea hindrance factor) that hinders the automatic open sea control (step S13). When there is no open sea hindrance factor (step S13: NO), the automatic open sea control is executed (step S14). The automatic open sea control includes a position sensor watercraft maneuvering control to cause the watercraft 1 to automatically travel along a planned route based on data of a current position acquired by the GPS receiver 46, which is an example of a position sensor. Further, the automatic open sea control further includes the obstacle avoidance control to control the propulsion device and the steering to avoid an obstacle based on the recognition process with respect to the image acquired by the automatic watercraft maneuvering camera 44.

When it is determined that there is an open sea hindrance factor (step S13: YES) and the automatic open sea control cannot be performed, the main controller 41 executes an open sea hindrance process.

The open sea hindrance process may include an alarm process to generate an alarm indicating that an open sea hindrance factor has occurred. The alarm process may be an alarm sound generation process, a notification process to the remote monitoring system 101 via the communication terminal 53, a notification process from the communication terminal 53 to a mobile terminal (for example, a smartphone held by a person in charge at a departure port or a destination port) registered in advance, or the like. The open sea hindrance process may include the automatic watercraft stop control. The automatic watercraft stop control stops the watercraft 1 to keep the watercraft 1 at the position. Specifically, the automatic watercraft stop control may include an at-anchor control to actuate the anchoring device 55 to anchor and berth the watercraft. Further, the automatic watercraft stop control may include a fixed point holding control to hold the current position of the watercraft 1 by controlling the propulsion device and the steering where possible. Further, depending on a specific hindrance factor, the open sea hindrance process may include an azimuth sensor watercraft maneuvering control to cause the watercraft to head to the departure port area of water or the destination port area of water while detecting an azimuth using the azimuth sensor 47.

For example, the open sea hindrance factors may include hindrance factors related to the automatic watercraft maneuvering camera 44, the remote watercraft maneuvering camera 45, the remote control ECU 52, the communication terminal 53, the GPS receiver 46, the radar 48, the millimeter wave radar 49, the electronic chart 50, the propulsion device (outboard motor 20), the steering (steering 30), and the like, and may further include other hindrance factors.

An open sea hindrance factor related to the automatic watercraft maneuvering camera 44 may be the same as the case of the unberthing hindrance factor. When an open sea hindrance factor related to the automatic watercraft maneuvering camera 44 occurs, the main controller 41 executes the watercraft stop control as the open sea hindrance process. In this case, where possible, it is possible to take necessary measures by switching to remote watercraft maneuvering from the remote monitoring system 101 (remote control step). When complete failure is a hindrance factor, the open sea hindrance process preferably includes the SOS transmission process. When backlight is a hindrance factor, the hindrance factor may be eliminated in some cases by changing the orientation of the watercraft 1 through remote watercraft maneuvering. Even in a case where the hindrance factor related to the automatic watercraft maneuvering camera 44 cannot be eliminated, it is preferable to wait for the hindrance factor to be eliminated while causing the watercraft 1 to head to the destination location through remote watercraft maneuvering as much as possible (particularly, in a case other than complete failure).

An open sea hindrance factor related to the remote watercraft maneuvering camera 45 may be the same as the case of the unberthing hindrance factor. When a hindrance factor related to the remote watercraft maneuvering camera 45 occurs, the main controller 41 executes the watercraft stop control. In this case, where possible, it is possible to take necessary measures by switching to remote watercraft maneuvering from the remote monitoring system 101 (remote control step). When complete failure is a hindrance factor, the open sea hindrance process preferably includes the SOS transmission process. For example, when the backlight is a hindrance factor, the hindrance factor may be eliminated in some cases by changing the orientation of the watercraft 1 through remote watercraft maneuvering. Even in a case where the hindrance factor related to the remote watercraft maneuvering camera 45 cannot be eliminated, it is preferable to wait for the hindrance factor to be eliminated while causing the watercraft 1 to head to the destination location through remote watercraft maneuvering as much as possible (particularly, in a case other than complete failure).

An open sea hindrance factor related to the remote control ECU 52 and an open sea hindrance factor related to the communication terminal 53 are similar to the case of the unberthing hindrance factor. The open sea hindrance process when there is an open sea hindrance factor related to the remote control ECU 52 or an open sea hindrance factor related to the communication terminal 53 preferably includes a process to cause the watercraft to head to the destination location through the automatic watercraft maneuvering control including the position sensor watercraft maneuvering control and the obstacle avoidance control. For example, the main controller 41 may perform the watercraft stop control after entering the destination port area of water and causing the watercraft 1 through the automatic watercraft maneuvering control to reach the vicinity of the destination location. Further, the main controller 41 may also perform the SOS transmission process.

An open sea hindrance factor related to the GPS receiver 46 may be similar to the case of the unberthing hindrance factor. The open sea hindrance process when “complete failure” of the GPS receiver 46 is detected preferably includes the watercraft stop control (watercraft stop step). Thereafter, where possible, it is preferable to switch to remote watercraft maneuvering using the remote monitoring system 101 to cause the watercraft 1 to head to the destination location (remote control step). When the GPS receiver 46 completely fails, the position detection cannot be performed. Therefore, the main controller 41 executes the determinations in steps S5 and S9 based on the last position information acquired immediately before the failure occurs in the GPS receiver 46. In a case where the last position information indicates the out-of-port area of water, it is determined whether or not there is an open sea hindrance factor (step S13). When “complete failure” of the GPS receiver 46 is detected, the watercraft stop control is executed. The open sea hindrance process when a hindrance factor related to the GPS receiver 46 is the “large error” preferably includes a process to continue the automatic watercraft maneuvering control including the position sensor watercraft maneuvering control and the obstacle avoidance control and causing the watercraft to head to the destination location. For example, the main controller 41 may perform the watercraft stop control after entering the destination port area of water and causing the watercraft 1 to reach a vicinity of the destination location using the automatic watercraft maneuvering control. Thereafter, where possible, it is preferable to switch to remote watercraft maneuvering using the remote monitoring system 101 to dock the watercraft 1 at the pier of the destination location. In the case of the “instantaneous interruption” and the “satellite loss,” a process similar to the in-port departure hindrance process may be executed as the open sea hindrance process. However, in a state in which the position data cannot be acquired, it is preferable to avoid remote watercraft maneuvering in the out-of-port area of water.

When “complete failure” of the GPS receiver 46 is detected in the out-of-port area of water, the main controller 41 may perform the automatic watercraft maneuvering control to cause the watercraft to head to the departure port area of water or the destination port area of water through the azimuth sensor watercraft maneuvering control to control the propulsion device and the steering while detecting an azimuth using the azimuth sensor 47 (azimuth sensor watercraft maneuvering step). More specifically, the main controller 41 determines whether the last position information detected by the GPS receiver 46 immediately before the failure indicates a position within a predetermined distance from the departure port area of water or the destination port area of water (for example, within 100 kilometers). When the last position information indicates a position within the predetermined distance from the departure port area of water, the main controller 41 causes the watercraft 1 to head to the departure port area of water through the azimuth sensor watercraft maneuvering control. In a case where the last position information indicates a position within the predetermined distance from the destination port area of water, the main controller 41 causes the watercraft 1 to head to the destination port area of water through the azimuth sensor watercraft maneuvering control. When the watercraft 1 arrives in the departure port area of water or the destination port area of water and a state in which the recognition process of land, a building, and the like can be performed from an image from the automatic watercraft maneuvering camera 44 is reached, the control may be switched to the camera watercraft maneuvering control and the watercraft 1 may return to the departure location or the destination location. Alternatively, the main controller 41 may execute the watercraft stop control to wait for remote watercraft maneuvering from the remote monitoring base 100. In a case where the last position information indicates the position of the out-of-port area of water, the main controller 41 preferably executes the watercraft stop control.

Open sea hindrance factors related to the radar 48 and the millimeter wave radar 49 are similar to the case of the unberthing hindrance factors. The open sea hindrance process when there is a hindrance factor related to the radar 48 or the millimeter wave radar 49 preferably includes the watercraft stop control. Then, where possible, it is preferable to switch to the remote control and perform the remote watercraft maneuvering such that the watercraft will head to the destination port (remote control step).

An open sea hindrance factor related to the electronic chart 50 may be similar to the case of the unberthing hindrance factor. The open sea hindrance process when a hindrance factor related to the electronic chart 50 occurs in the out-of-port area of water is preferably a process to return to the departure port through the automatic watercraft maneuvering control (the position sensor watercraft maneuvering control and the obstacle avoidance control).

As in the case of the unberthing hindrance factors, open sea hindrance factors related to the propulsion device include a hindrance factor related to the shift mechanism 26 and a hindrance factor related to the throttle. The open sea hindrance process when a hindrance factor related to the propulsion device occurs preferably includes a process to continue automatic watercraft maneuvering and cause the watercraft to head to the vicinity of the destination location. For example, the main controller 41 may perform the watercraft stop control after entering the destination port area of water and causing the watercraft 1 to reach the vicinity of the destination location through the automatic watercraft maneuvering control. Thereafter, where possible, it is preferable to switch to the remote control using the remote monitoring system 101 to dock the watercraft 1 at the pier of the destination location. However, when the shift mechanism 26 is fixed at the neutral shift position, the propulsion device cannot generate a propulsive force. The open sea hindrance process in this case includes the watercraft stop control on the spot without causing the watercraft to head to the vicinity of the destination location. The open sea hindrance process may include the SOS transmission process.

An open sea hindrance factor related to the steering may also be similar to the case of the unberthing hindrance factor. The open sea hindrance process in a case where a hindrance factor related to the steering occurs preferably includes the watercraft stop control. Further, the open sea hindrance process in this case preferably includes the SOS transmission process. When the steering is stuck in the straight traveling state, the course of the watercraft 1 can be changed by adjusting a magnitude relationship of the propulsive forces of the right and left propulsion devices (outboard motors 20P and 20S). Therefore, after switching to remote watercraft maneuvering to cause the watercraft 1 to travel to the vicinity of the destination location, the watercraft stop control and the SOS transmission process may be performed.

Other examples of the open sea hindrance factors may include collision with an obstacle such as an embankment or another watercraft, and traveling in shallow water. These can be detected by providing an appropriate sensor and recognized by the main controller 41. When these hindrance factors occur, the main controller 41 preferably performs the watercraft stop control and the SOS transmission process as the open sea hindrance process. Further, the main controller 41 may, in some cases, cancel the position sensor watercraft maneuvering control. Specifically, there are a case where the route cannot be restored to the planned route due to the influence of a strong water flow or the like, and a case where the recognition process with respect to the image from the automatic watercraft maneuvering camera 44 is poor due to lack of brightness and it becomes difficult to perform the obstacle avoidance control, and the like. When these hindrance factors occur, the main controller 41 preferably performs the watercraft stop control as the open sea hindrance process. Then, as much as possible, it is preferable to switch to the remote watercraft maneuvering from the remote monitoring system 101 and try to return to the route toward the destination location (remote control step).

By causing the watercraft 1 to travel in accordance with the traveling route in the out-of-port area of water, the watercraft 1 enters the destination port area of water (step S9: YES). As a result, the main controller 41 determines whether or not to execute (start or continue) the automatic in-port destination control. Specifically, it is determined whether or not there is an in-port destination hindrance factor which is a hindrance factor of the execution (start or continuation) of the automatic in-port destination control (step S10). When it is determined that there is no in-port destination hindrance factor (step S10: NO), the automatic in-port destination control is executed (step S11). The automatic in-port destination control may be, for example, a control of causing the watercraft 1 to automatically travel along a planned route using the camera watercraft maneuvering control while automatically analyzing an image (video) of the surroundings of the watercraft captured by the automatic watercraft maneuvering camera 44. When there is an in-port destination hindrance factor (step S10: YES) and the automatic in-port destination control is not executable, the main controller 41 executes an in-port destination hindrance process (step S12).

The in-port destination hindrance process may include an alarm process to generate an alarm indicating that the in-port destination hindrance factor has occurred. The alarm process may be an alarm sound generation process, a notification process to the remote monitoring system 101 via the communication terminal 53, a notification process from the communication terminal 53 to a mobile terminal (for example, a smartphone held by a person in charge at a destination port) registered in advance, or the like. The in-port destination hindrance process may include the automatic watercraft stop control. The automatic watercraft stop control stops the watercraft 1 to keep the watercraft 1 at the current position. Specifically, the automatic watercraft stop control may include an at-anchor control to actuate the anchoring device 55 to anchor and berth the watercraft. Further, the automatic watercraft stop control may include a fixed point holding control to hold the current position of the watercraft 1 by controlling the propulsion device and the steering where possible. Further, the in-port destination hindrance process may include, depending on a specific hindrance factor, a camera watercraft maneuvering docking process to dock the watercraft at the destination location using the camera watercraft maneuvering control.

For example, in-port destination hindrance factors may include hindrance factors related to the automatic watercraft maneuvering camera 44, the remote watercraft maneuvering camera 45, the remote control ECU 52, the communication terminal 53, the GPS receiver 46, the radar 48, the millimeter wave radar 49, the electronic chart 50, the propulsion device (outboard motor 20), the steering (steering 30), and the like, and may further include other hindrance factors.

An in-port destination hindrance factor related to the automatic watercraft maneuvering camera 44 may be similar to the case of the unberthing hindrance factor. When a hindrance factor related to the automatic watercraft maneuvering camera 44 occurs, the main controller 41 executes the watercraft stop control as the in-port destination hindrance process. In this case, where possible, it is possible to take necessary measures by switching to remote watercraft maneuvering from the remote monitoring system 101 (remote control step). In a case where complete failure is a hindrance factor, the in-port destination hindrance process preferably includes the SOS transmission process. When backlight is a hindrance factor, the hindrance factor may be eliminated in some cases by changing the orientation of the watercraft 1 through remote watercraft maneuvering. In a case where the hindrance factor related to the automatic watercraft maneuvering camera 44 cannot be eliminated, the watercraft 1 is preferably docked at the pier of the destination location through remote watercraft maneuvering as much as possible.

An in-port destination hindrance factor related to the remote watercraft maneuvering camera 45 may be similar to the case of the unberthing hindrance factor. When a hindrance factor related to the remote watercraft maneuvering camera 45 occurs, the main controller 41 executes the watercraft stop control. In this case, where possible, it is possible to take necessary measures by switching to remote watercraft maneuvering from the remote monitoring system 101 (remote control step). In a case where complete failure is a hindrance factor, the in-port destination hindrance process preferably includes the SOS transmission process. For example, when backlight is a hindrance factor, the hindrance factor may be eliminated in some cases by changing the orientation of the watercraft 1 through remote watercraft maneuvering. In a case where the hindrance factor cannot be eliminated, the watercraft 1 is preferably docked at the pier of the destination location through remote watercraft maneuvering as much as possible.

An in-port destination hindrance factor related to the remote control ECU 52 may be similar to the case of the unberthing hindrance factor. The in-port destination hindrance process when there is a hindrance factor related to the remote control ECU 52 preferably includes an automatic watercraft maneuvering process to dock the watercraft at the pier of the destination location through camera watercraft maneuvering control.

An in-port destination hindrance factor related to the communication terminal 53 may be similar to the case of the unberthing hindrance factor. The in-port destination hindrance process when there is a hindrance factor related to the communication terminal 53 preferably includes the watercraft stop control and the SOS transmission process.

The in-port destination hindrance factor related to the GPS receiver 46 may be similar to the case of the unberthing hindrance factor. Since the automatic watercraft maneuvering in the destination port area of water is performed by the camera watercraft maneuvering control, it is not necessary to use the position data detected by the GPS receiver 46. Therefore, the in-port destination hindrance process for the hindrance factor related to the GPS receiver 46 is preferably a process to dock the watercraft at the pier of the destination location (an example of a predetermined target position) through automatic watercraft maneuvering using the camera watercraft maneuvering control (camera watercraft maneuvering step).

In-port destination hindrance factors related to the radar 48, the millimeter wave radar 49, and the electronic chart 50 may be similar to the case of the unberthing hindrance factors. Since the automatic watercraft maneuvering in the destination port area of water is performed using the camera watercraft maneuvering control, the automatic watercraft maneuvering can be continued even when a hindrance factor related to the radar 48, the millimeter wave radar 49, or the electronic chart 50 occurs. Therefore, the in-port destination hindrance process when there is a hindrance factor related to the radar 48, the millimeter wave radar 49, or the electronic chart 50 may preferably include the automatic watercraft maneuvering process to dock the watercraft at the pier of the destination location using the camera watercraft maneuvering control.

As in the case of the unberthing hindrance factor, in-port destination hindrance factors related to the propulsion device may include a hindrance factor related to the shift mechanism 26 and a hindrance factor related to the throttle. Further, a hindrance factor related to the steering may also be similar to the case of the unberthing hindrance factor. The in-port destination hindrance process in a case where a hindrance factor related to the propulsion device or the steering occurs preferably includes the watercraft stop control. Further, the in-port destination hindrance process in this case preferably includes the SOS transmission process. In a case where a hindrance factor has occurred in the propulsion device or the steering, it is generally difficult to dock the watercraft 1 at the pier of the destination location through remote watercraft maneuvering.

Other examples of the in-port destination hindrance factor include collision with an obstacle such as an embankment or another watercraft, and traveling in shallow water. These can be detected by providing an appropriate sensor and recognized by the main controller 41. When these hindrance factors occur, the main controller 41 preferably performs the watercraft stop control and the SOS transmission process as the in-port destination hindrance process. Further, the main controller 41 may, in some cases, cancel the camera watercraft maneuvering control based on the image acquired by the automatic watercraft maneuvering camera 44. Specifically, there are a case where a bank gap cannot be recognized from the image acquired by the automatic watercraft maneuvering camera 44, a case where the route cannot be restored to the planned route due to the influence of a strong water flow or the like, and a case where the recognition process with respect to the image of the automatic watercraft maneuvering camera 44 becomes poor due to lack of brightness. When these hindrance factors occur, the main controller 41 preferably performs the watercraft stop control as the in-port destination hindrance process, and preferably performs the SOS transmission process together. Where possible, it is preferable to switch to the remote watercraft maneuvering to dock the watercraft 1 at the pier of the destination location (remote control step). However, it is more preferable that the person in charge at the destination location gets on the watercraft 1 and docks the watercraft at the pier at the destination location by manual watercraft maneuvering.

As described above, according to the present example embodiment, the main controller 41 can appropriately execute the automatic watercraft maneuvering control based on autonomous determination depending on the situation. More specifically, the main controller 41 determines whether the watercraft is before departure, during traveling in the departure port area of water, during traveling in the destination port area of water, or during traveling in the out-of-port area of water, and executes an appropriate hindrance process according to a hindrance factor. As a result, for example, even when a failure occurs in the GPS receiver 46 (position sensor) in the departure port area of water or the destination port area of water in which the watercraft can travel using the camera watercraft maneuvering control (more specifically, only using the camera watercraft maneuvering control), the automatic watercraft maneuvering using the camera watercraft maneuvering control can be continued. On the other hand, in a case where a failure occurs in the GPS receiver 46 in the out-of-port area of water in which the position sensor watercraft maneuvering control is used, the watercraft 1 can be stopped. Further, even when the GPS receiver 46 has failed in the out-of-port area of water, when the last position information indicates a position within a predetermined distance from the departure port area of water or the destination port area of water, the main controller 41 can guide the watercraft 1 to the departure port area of water or the destination port area of water by executing the azimuth sensor watercraft maneuvering control.

While example embodiments of the present invention have thus been described, the present invention may be embodied in some other ways.

For example, the above hindrance factors are exemplary, and determinations for fewer or more hindrance factors may be made by the main controller 41. Further, as for a hindrance process to address each hindrance factor, an appropriate process different from that in the above description may be performed by the main controller 41.

In the above example embodiments, the outboard motor is used as the propulsion device as an example, but a configuration of a propulsion device provided on the watercraft may be any of various types such as inboard motors, inboard/outboard motors and waterjet propulsion devices. Further, at least one propulsion device may be provided, and three or more propulsion devices may be provided.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An automatic watercraft maneuvering system comprising:
a propulsion device to propel a watercraft;
a steering to change a course of the watercraft;
a position sensor to acquire position information of the watercraft;
a camera to image surroundings of the watercraft; and
a controller configured or programmed to execute an automatic watercraft maneuvering control to control the propulsion device and the steering in order to perform automatic watercraft maneuvering from a departure location to a destination location; wherein
the automatic watercraft maneuvering control includes a camera watercraft maneuvering control to execute a recognition process with respect to an image acquired by the camera and a control of the propulsion device and the steering based on the recognition process, and a position sensor watercraft maneuvering control to control the propulsion device and the steering based on the position information acquired by the position sensor; and
the controller is configured or programmed to, when a failure occurs in the position sensor in a predetermined area of water in which the automatic watercraft maneuvering is executable only using the camera watercraft maneuvering control, cause the watercraft to head to a predetermined target position in the predetermined area of water in which the failure occurs during the camera watercraft maneuvering control.

2. The automatic watercraft maneuvering system according to claim 1, wherein the predetermined target position is the departure location or the destination location.

3. The automatic watercraft maneuvering system according to claim 1, wherein the controller is configured or programmed to execute the position sensor watercraft maneuvering control outside the predetermined area of water.

4. The automatic watercraft maneuvering system according to claim 3, wherein the controller is configured or programmed to further execute an obstacle avoidance control to control the propulsion device and the steering such that the watercraft avoids an obstacle based on the recognition process with respect to the image acquired by the camera outside the predetermined area of water.

5. The automatic watercraft maneuvering system according to claim 3, wherein the controller is configured or programmed to execute a watercraft stop control to stop the watercraft in a case where last position information acquired immediately before a failure occurs in the position sensor indicates a position outside the predetermined area of water.

6. The automatic watercraft maneuvering system according to claim 3, further comprising:
an azimuth sensor to acquire azimuth information of the watercraft; wherein
the controller is configured or programmed to, when a failure occurs in the position sensor outside the predetermined area of water, execute an azimuth sensor watercraft maneuvering control to control the propulsion device and the steering such that the watercraft approaches the predetermined area of water by using the azimuth information acquired by the azimuth sensor.

7. The automatic watercraft maneuvering system according to claim 6, wherein the controller is configured or programmed to execute the azimuth sensor watercraft maneuvering control in a case where last position information acquired immediately before the failure occurs in the position sensor indicates a position within a predetermined distance from the predetermined area of water, and not to execute the azimuth sensor watercraft maneuvering control but to execute the watercraft stop control to stop the watercraft in a case where the last position information indicates a position outside the predetermined distance from the predetermined area of water.

8. The automatic watercraft maneuvering system according to claim 1, further comprising:
a communication terminal to communicate with a remote watercraft maneuvering base to remotely operate the propulsion device and the steering; wherein
the controller is configured or programmed to execute a remote control to notify the remote watercraft maneuvering base of state information of the automatic watercraft maneuvering system by using the communication terminal, and control the propulsion device and the steering based on a remote operation signal received from the remote watercraft maneuvering base via the communication terminal.

9. The automatic watercraft maneuvering system according to claim 8, wherein the state information of the automatic watercraft maneuvering system includes a watercraft stop control information indicating whether the controller is executing a watercraft stop control to stop the watercraft.

10. A watercraft comprising:
a hull; and
an automatic watercraft maneuvering system on the hull including:
a propulsion device to propel a watercraft;
a steering to change a course of the watercraft;
a position sensor to acquire position information of the watercraft;
a camera to image surroundings of the watercraft; and
a controller configured or programmed to execute an automatic watercraft maneuvering control to control the propulsion device and the steering in order to perform automatic watercraft maneuvering from a departure location to a destination location; wherein
the automatic watercraft maneuvering control includes a camera watercraft maneuvering control to execute a recognition process with respect to the image acquired by the camera and a control of the propulsion device and the steering based on the recognition process, and a position sensor watercraft maneuvering control to control the propulsion device and the steering based on the position information acquired by the position sensor; and
the controller is configured or programmed to, when a failure occurs in the position sensor in a predetermined area of water in which the automatic watercraft maneuvering is executable using the camera watercraft maneuvering control, cause the watercraft to head to a predetermined target position in the predetermined area of water in which the failure occurs during the camera watercraft maneuvering control.

11. A watercraft control method to control, with a controller, a propulsion device to propel a watercraft and a steering to change a course of the watercraft, the watercraft control method comprising:
an automatic watercraft maneuvering control to execute, with the controller, an automatic watercraft maneuvering control to control the propulsion device and the steering in order to perform automatic watercraft maneuvering from a departure location to a destination location based on an output signal of a position sensor that acquires position information of the watercraft and an output signal of a camera that images of surroundings of the watercraft; wherein
the automatic watercraft maneuvering control includes a camera watercraft maneuvering control to execute a recognition process with respect to an image acquired by the camera and a control of the propulsion device and the steering based on the recognition process, and a position sensor watercraft maneuvering control to control the propulsion device and the steering based on the position information acquired by the position sensor; and
the watercraft control further includes a camera watercraft maneuvering control to, when a failure occurs in the position sensor in a predetermined area of water in which the automatic watercraft maneuvering is executable using the camera watercraft maneuvering control, cause the watercraft to head to a predetermined target position in the predetermined area of water in which the failure occurs during the camera watercraft maneuvering control.

12. The watercraft control method according to claim 11, wherein the predetermined target position is the departure location or the destination location.

13. The watercraft control method according to claim 11, wherein in the automatic watercraft maneuvering control, the controller executes the position sensor watercraft maneuvering control outside the predetermined area of water.

14. The watercraft control method according to claim 13, wherein in the automatic watercraft maneuvering control, the controller further executes an obstacle avoidance control to control the propulsion device and the steering such that the watercraft avoids an obstacle based on the recognition process with respect to the image acquired by the camera outside the predetermined area of water.

15. The watercraft control method according to claim 13, further comprising a watercraft stop control to execute, with the controller, a watercraft stop control to stop the watercraft in a case where last position information acquired immediately before a failure occurs in the position sensor indicates a position outside the predetermined area of water.

16. The watercraft control method according to claim 13, further comprising an azimuth sensor watercraft maneuvering control to execute, with the controller, an azimuth sensor watercraft maneuvering control to control the propulsion device and the steering such that the watercraft approaches the predetermined area of water using the azimuth information acquired by the azimuth sensor when a failure occurs in the position sensor outside the predetermined area of water.

17. The watercraft control method according to claim 16, wherein
the azimuth sensor watercraft maneuvering control is executed in a case where last position information acquired immediately before a failure occurs in the position sensor indicates a position within a predetermined distance from the predetermined area of water; and
the watercraft control further includes a watercraft stop control to not execute the azimuth sensor watercraft maneuvering control but to execute, with the controller, a watercraft stop control to stop the watercraft in a case where the last position information indicates a position outside the predetermined distance from the predetermined area of water.

18. The watercraft control method according to claim 11, further comprising:
controlling a communication terminal, with the controller, to communicate with a remote watercraft maneuvering base to remotely operate the propulsion device and the steering; wherein
the watercraft control further includes a remote control to notify, with the controller, the remote watercraft maneuvering base of state information of the watercraft using the communication terminal, and control the propulsion device and the steering based on a remote operation signal received from the remote watercraft maneuvering base via the communication terminal.

19. The watercraft control method according to claim 18, wherein the state information of the watercraft includes a watercraft stop control information indicating whether the controller is executing a watercraft stop control to stop the watercraft.
